(19) United States
(12) Patent Application Publication
(10) Pub. No.: US 2011/0083108 A1
(43) Pub. Date: Apr. 7, 2011

(54) PROVIDING USER INTERFACE FEEDBACK REGARDING CURSOR POSITION ON A DISPLAY SCREEN

(75) Inventors: Christian Klein, Duvall, WA (US); Ali Vassigh, Redmond, WA (US)

(73) Assignee: Microsoft Corporation, Redmond, WA (US)

(21) Appl. No.: 12/573,282

(22) Filed: Oct. 5, 2009

(51) Int. Cl. G06F 3/048

(52) U.S. Cl. 715/859; 715/856

(57) ABSTRACT

Disclosed herein are systems and methods for providing user interface feedback regarding a cursor position on a display screen. A user may use a suitable input device for controlling a cursor in a computing environment. The displayed objects may provide feedback regarding the cursor's position. Particularly, a position of the cursor may be compared to an object's position for determining whether the cursor is positioned on the display screen at the same position as a portion of the object or within a predetermined distance of the portion of the object. In response to determining the cursor is positioned on the display screen at the same position as the portion of the object or within the predetermined distance of the portion of the object, an appearance of the portion of the object may be altered, such as, for example, brightness or color of the object portion.

### BACKGROUND

Many computing applications such as computer games, multimedia applications, or the like use controls to allow users to manipulate cursors, game characters, or other aspects of an application. Today, designers and engineers in the area of consumer devices, such as computers, televisions, DVRs, game consoles, and appliances, have many options for user-device interaction with a cursor. Input techniques may leverage a remote control, keyboard, mouse, stylus, game controller, touch, voice, gesture, and the like. For example, an image capture device can detect user gestures for controlling a cursor. For any given technique, the design of user interface feedback is critical to help users interact more effectively and efficiently with the device.

One of the most well-known input mechanisms and interaction feedback designs is the mouse and on-screen cursor. The design of each has evolved and been refined over many years. In addition, on-screen cursor feedback has even been decoupled from the mouse and applied to other forms of user input where targeting on-screen objects, such as buttons, or other elements is essential to avoid user frustration.

Effective targeting and other gestural interactions using a cursor require real-time user interface feedback indicating the cursor's position to the user. However, displaying a traditional cursor graphic, such as an arrow, at the exact position of the cursor suffers from a variety of disadvantages. In a real-world gestural system, where lag and jitter are difficult to avoid and reliable cursor control requires use of more sophisticated targeting assistance techniques, the disadvantages of displaying a graphic at the precise position of the cursor are magnified. The cursor precision suggested by such a graphic and consequently expected by the user is poorly matched with the realities of the system.

Accordingly, it is desirable to provide systems and methods for improving user interface feedback regarding cursor position on a display screen of an audiovisual device.

### SUMMARY

Disclosed herein are systems and methods for providing user interface feedback regarding a cursor position on a display screen of an audiovisual device. According to one embodiment, a user may use a suitable input device for controlling a cursor in a computing environment. The actual position of the cursor may not be displayed on a display screen in the computing environment. In other words, the cursor's actual position may be hidden from the user's view. However, in accordance with the presently disclosed subject matter, the displayed objects may provide feedback regarding the cursor's position. Particularly, a position of the cursor may be compared to an object's position for determining whether the cursor is positioned on the display screen at the same position as a portion of the object or within a predetermined distance of the portion of the object. In response to determining the cursor is positioned on the display screen at the same position as the portion of the object or within the predetermined distance of the portion of the object, an appearance of the portion of the object may be altered. For example, brightness, color, or other appearance of the portion of the object may be altered for indicating to the user that the cursor's position is near the portion of the object. These techniques and other disclosed herein can be advantageous in gestural systems, for example, or other systems for overcoming difficulties of lag and jitter and unreliable cursor control.

In another embodiment of the subject matter disclosed herein, a plurality of objects displayed on a display screen may be utilized for providing user feedback regarding a cursor's position. The cursor's position with respect to the objects' positions may be determined. Particularly, it is determined whether the cursor is positioned on the display screen at the same position as one or more of the objects or within a predetermined distance of one or more of the objects. Input from the user for controlling movement of the cursor is received. In response to the user control of the cursor, an appearance of one or more of the objects is altered if the cursor is positioned on the display screen at the same position as the object(s) or within a predetermined distance of the object(s). Further, in response to the user control of the cursor, one or more of the objects can move if the cursor is positioned on the display screen at the same position as the object(s) or within a predetermined distance of the object(s). Accordingly, one or more objects may move or the objects' appearance may change in response to user control of the cursor based on the cursor's proximity to the object(s).

In yet another embodiment of the subject matter disclosed herein, user input is received in a computing environment based on cursor position. Particularly, a cursor's position with respect to a display screen is determined when the cursor is positioned off of the display screen. For example, as opposed to the cursor being positioned within a display screen, a computing environment may track a cursor's position when the cursor has moved outside of the bounds of the display screen. A user may move the cursor off of the display screen and continue to move the cursor outside the bounds of the display screen. This movement may be tracked by the computing environment, and the cursor's position stored in memory. While the cursor's position is outside the bounds of the display screen, a direction of the cursor's position with respect to the display screen may be indicated such as, for example, by a displayed object. The positioning of the displayed object may be adjacent or otherwise near a side of the display screen that is closest to the cursor's position for indicating that the cursor's position is in that direction with respect to the display screen. In response to the user's control of the cursor when the cursor is positioned off of the display screen, an element, or another object on the display screen, may be controlled based on the cursor's position. For example, one or more objects on the display screen may be manipulated (e.g., rotated or otherwise moved) based on movement of the cursor off of the display screen. In this way, even though the cursor's position is not on the display screen, movement of the cursor may control displayed elements.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The systems, methods, and computer readable media for altering a view perspective within a virtual environment in accordance with this specification are further described with reference to the accompanying drawings in which:

FIG. 1 depicts a flow diagram of an example method for providing user interface feedback regarding a cursor position on a display screen;

FIG. 2 depicts an exemplary display screen displaying a plurality of rectangular-shaped target objects positioned among each other with high density;

FIG. 3 depicts a flow diagram of another example method for providing user interface feedback regarding a cursor position on a display screen;

FIG. 4 depicts an exemplary display screen displaying objects that may be altered based on a cursor's position as described herein;

FIG. 5 depicts a flow diagram of an example method for receiving user input based on cursor position;

FIG. 6 illustrates an example embodiment of a computing environment that may be used to provide user interface feedback regarding a cursor position on a display screen of an audiovisual device; and

FIG. 7 illustrates another example embodiment of a computing environment that may be used to provide user interface feedback regarding a cursor position on a display screen of an audiovisual device.

### DETAILED DESCRIPTION OF ILLUSTRATIVE EMBODIMENTS

As will be described herein, user interface feedback may be provided regarding a cursor position on a display screen of an audiovisual device. According to one embodiment, a user may use gestures, a mouse, a keyboard, or the like to control a cursor in a computing environment. The actual position of the cursor may not be displayed on a display screen in the computing environment, such as by use of an arrow-shaped object to show the cursor's exact position; however, in accordance with the presently disclosed subject matter, the one or more displayed objects may provide feedback regarding the cursor's position. Particularly, a position of the cursor may be compared to an object's position for determining whether the cursor is positioned on the display screen at the same position as a portion of the object or within a predetermined distance of the portion of the object. In response to determining the cursor is positioned on the display screen at the same position as the portion of the object or within the predetermined distance of the portion of the object, an appearance of the portion of the object may be altered. For example, brightness, color, or other appearance of the portion of the object may be altered for indicating to the user that the cursor's position is near the portion of the object.

In another embodiment of the subject matter disclosed herein, a plurality of objects displayed on a display screen may be utilized for providing user feedback regarding a cursor's position. The cursor's position with respect to the objects' positions may be determined. Particularly, it is determined whether the cursor is positioned on the display screen at the same position as one or more of the objects or within a predetermined distance of one or more of the objects. Input from the user for controlling movement of the cursor is received. In response to the user control of the cursor, an appearance of one or more of the objects is altered if the cursor is positioned on the display screen at the same position as the object(s) or within a predetermined distance of the object(s). Further, in response to the user control of the cursor, one or more of the objects can move if the cursor is positioned on the display screen at the same position as the object(s) or within a predetermined distance of the object(s). Accordingly, one or more objects may move or the objects' appearance may change in response to user control of the cursor based on the cursor's proximity to the object(s).

In yet another embodiment of the subject matter disclosed herein, user input is received in a computing environment based on cursor position. Particularly, a cursor's position with respect to a display screen is determined when the cursor is positioned off of the display screen. For example, as opposed to the cursor being positioned within a display screen, a computing environment may track a cursor's position when the cursor has moved outside of the bounds of the display screen. A user may move the cursor off of the display screen and continue to move the cursor outside the bounds of the display screen. This movement may be tracked by the computing environment, and the cursor's position stored in memory. While the cursor's position is outside the bounds of the display screen, a direction of the cursor's position with respect to the display screen may be indicated such as, for example, by a displayed object. The positioning of the displayed object may be adjacent or otherwise near a side of the display screen that is closest to the cursor's position for indicating that the cursor's position is in that direction with respect to the display screen. In response to the user's control of the cursor when the cursor is positioned off of the display screen, an element, or another object on the display screen, may be controlled based on the cursor's position. For example, one or more objects on the display screen may be manipulated (e.g., rotated or otherwise moved) based on movement of the cursor off of the display screen. In this way, even though the cursor's position is not on the display screen, movement of the cursor may still control displayed elements.

A user may control a cursor's position by using any number of suitable user input devices such as, for example, a mouse, a trackball, a keyboard, an image capture device, or the like. A user may control a cursor displayed in a computing environment such as a game console, a computer, or the like. In an example of controlling a cursor's position, a mouse may be moved over a surface for controlling a direction of movement, speed of movement, positioning of a cursor on and off of a display screen, and the like. In yet another example, the keys of a keyboard (e.g., the direction arrow keys) may be configured for controlling the cursor.

In an exemplary embodiment, user gestures may be detected by, for example, an image capture device. For example, the capture device may capture a depth image of a scene including a user. In one embodiment, the capture device may determine whether one or more targets or objects in the scene correspond to a human target such as the user. If the capture device determines that one or more objects in the scene is a human, it may determine the depth to the human as well as the size of the human. The device may then center a virtual screen around each human target based on stored information, such as, for example a look up table that matches size of the person to wingspan and/or personal profile information. Each target or object that matches the human pattern may be scanned to generate a model such as a skeletal model, a mesh human model, or the like associated therewith. The model may then be provided to the computing environment such that the computing environment may track the model, determine which movements of the model are inputs for controlling an activity of a cursor, and render the cursor's activity based on the control inputs. Accordingly, the user's movements can be tracked by the capture device for controlling a direction of movement, speed of movement, positioning of a cursor on and off of a display screen, and the like.

An audiovisual device may be any type of display, such as a television, a monitor, a high-definition television (HDTV), or the like that may provide game or application visuals and/or audio to a user. For example, a computing environment may include a video adapter such as a graphics card and/or an audio adapter such as a sound card that may provide audiovisual signals associated with the game application, non-game application, or the like. The audiovisual device may receive the audiovisual signals from the computing environment and may then output the game or application visuals and/or audio associated with the audiovisual signals to the user. For example, a user may control a user input device for inputting control information for controlling or altering objects displayed on the display screen based on cursor positioning in accordance with the subject matter disclosed herein. According to one embodiment, the audiovisual device may be connected to the computing environment via, for example, an S-Video cable, a coaxial cable, an HDMI cable, a DVI cable, a VGA cable, or the like.

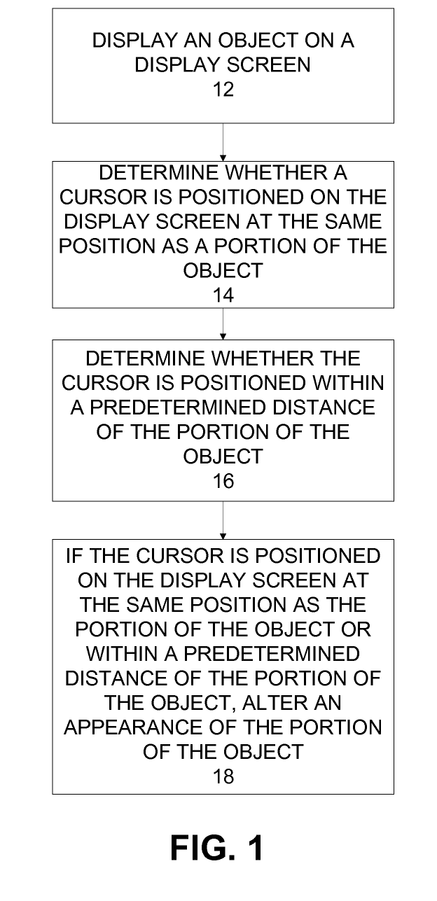

FIG. 1 depicts a flow diagram of an example method for providing user interface feedback regarding a cursor position on a display screen. The example method may provide one or more indirect cues that collectively indicate a cursor's position on a display screen of an audiovisual display operating within a computing environment, computer, or the like. An actual position of the cursor on the display screen may be invisible to a user. Rather, the cursor's approximate position is revealed in real-time to the user by one or more objects on the display screen that provide cues as to the cursor's exact position. Simultaneous feedback about the cursor's position is provided on one or more objects, including but not limited to the object that currently has focus based on the cursor's position. In an example embodiment, the movement of the cursor may be controlled based on a one or more user gestures, other inputs, or combinations thereof. The example method 10 may be implemented using, for example, an image capture device and/or a computing environment. The object(s) that indicate the cursor's position and/or movement based on the user's input may be displayed on any suitable type of display, such as an audiovisual display.

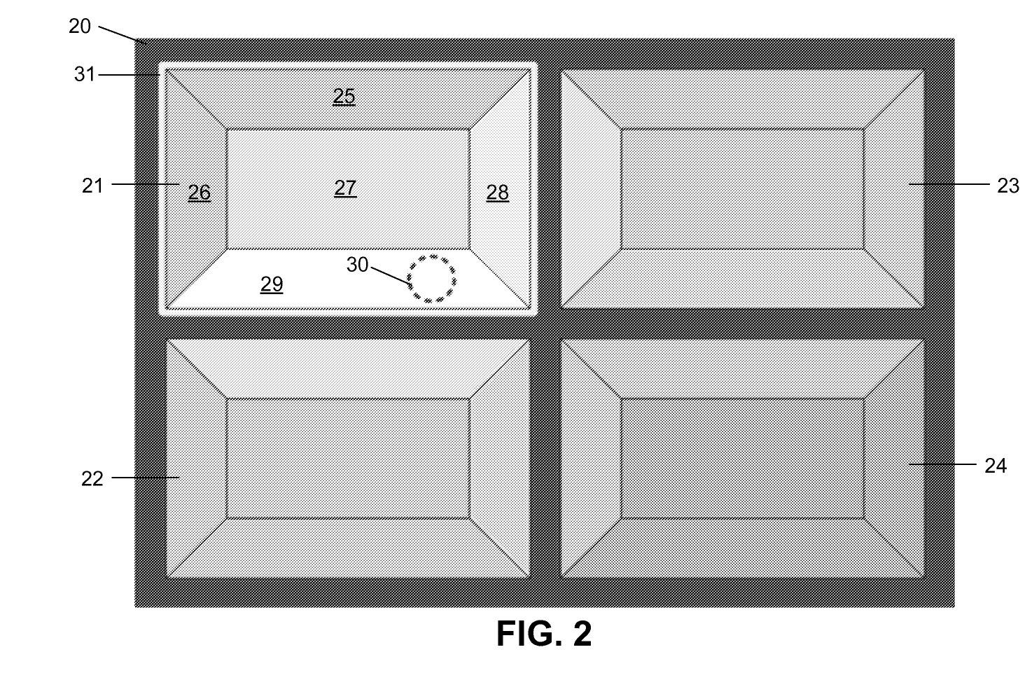

At 12, an object may be displayed on a display screen. FIG. 2 depicts an exemplary display screen 20 displaying a plurality of rectangular-shaped target objects 21-24 positioned among each other with high density. Referring also to FIG. 2, the object 21 has multiple facets or portions 25-29 visible to a user or viewer of the display screen 20. Alternatively, the objects can have portions that are invisible to a user and that are only revealed when a cursor's position is at the same position as the portion or within a predetermined distance of the portion of the object.

At 14 of FIG. 1, it is determined whether a cursor is positioned on the display screen at the same position as a portion of the object. For example, in FIG. 2, a circular shape 30 indicates an actual position of a cursor on the display screen 20. It is noted that the shape 30 is not displayed on the display screen 20, but rather, the shape 30 is merely shown for the purpose of showing the cursor's exact position and positions within a predetermined distance of the cursor's exact position. The computer or computing environment associated with the display screen 20 can store information regarding the position of the cursor, and can compare the stored position to the position of portions 25-29 of the object 21 as well as other objects on the display screen 200. With this information, the computer can determined whether the cursor is at the same position as any of the portions of the objects. In this example, the cursor's position, as indicated by the shape 30, is at the same position as portion 29 of the object 21.

At 16 of FIG. 1, it is determined whether the cursor is positioned on the display screen within a predetermined distance of the portion of the object. In FIG. 2, for example, the shape 30 not only indicates the exact position of the cursor, but the shape 30 also indicates positions on the display screen that are within a predetermined distance of the cursor's exact position. In this example, only portion 29 of the object 21 is positioned within the predetermined distance of the cursor's exact position, as indicated by the shape 29.

At 18 of FIG. 1, if the cursor is positioned on the display screen at the same position as the portion of the object or within a predetermined distance of the portion of the object, an appearance of the portion of the object is altered. In the FIG. 2, the cursor's position and positions within the predetermined distance of the cursor's position, as designated by shape 30, are all within the portion 29. Therefore, in this example, the appearance of the portion 29 is altered such that the portion's appearance is brightened. As shown, the portion 29 appears illuminated in comparison to the other portion of the object 21 and the portions of the other displayed objects 22-24. As a result, the cursor's position appears to a view as a “light source” for illuminating objects and objects portions near the cursor's actual position. In this way, a viewer of the display screen 20 can intuitively recognize that the cursor's position is at or near the portion 29 of the object 21. As the cursor's position is controlled by the viewer to move on the display screen, it may appear to the viewer that the light source's position is being controlled by the viewer.

It should be noted that the appearances of a plurality of portions of the same object and/or portions of other objects can be simultaneously altered due to the cursor's position. In the particular example of FIG. 2, the cursor's position is such that only the appearance of portion 29 is altered, because the cursor's exact position and positions within the predetermined distance of the cursor's exact position are all within the portion 29. It should be appreciated that the cursor's position can be such that more than one portion of an object and/or portions of multiple objects can be within the predetermined distance such that the appearance of these portions will be altered. The predetermined distance can be varied for increasing the influence of the cursor's position on altering the appearances of nearby objects and object portions.

The appearance of an object or a portion of the object may be altered by changing its brightness, its color, or the like. Although in the example of FIG. 2, the objects 21-24 include multiple facets that are visible to a viewer, objects may include portions that are not as well-defined in appearance such as, for example, contours, the appearance of which can be altered based on the cursor's positioning in accordance with the disclosed subject matter. Other changes in the appearance of an object or its portions include casting shadows from the portion. Further, a result of the cursor being near the object or its portion can be displayed by showing the result of treating the cursor as a source of heat, fire, wind, magnetism, another other visual distortion, or the like. In addition, an object may include invisible or hidden portions, the appearance of which only becomes visible to a viewer when the portion is at the same position of the cursor or within the predetermined distance of the cursor's position. In another example, if the cursor is positioned at a text label, normally hidden facets surrounding the object can be altered by the cursor's position.

Objects 21-24 can be configured for selection for user input when the cursor is positioned on the display screen 20 at the same position as the object. When the cursor is at the same position as the object, the object can receive focus such that it can receive user input. An example is the case when a cursor is over an object, such as a button, that can be selected for input associated with the object when the cursor is on the object and one of the mouse buttons is clicked. In another example, the cursor's position can provide lighting and/or shadows on an avatar when in proximity to the avatar. In the depicted example, the object 21 has received focus, and this is indicated by a border 31 surrounding the object 21. The other objects 22-24 can also receive focus when the cursor's position is at the object.

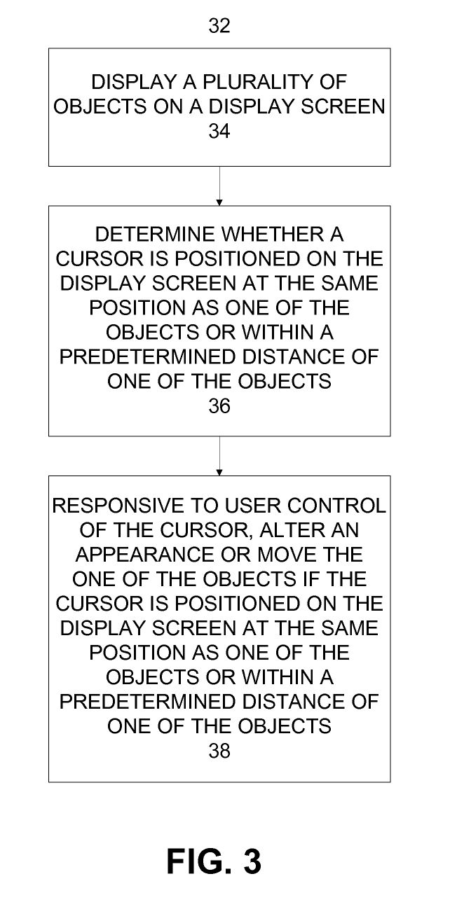

FIG. 3 depicts a flow diagram of another example method for providing user interface feedback regarding a cursor position on a display screen. The example method 32 may provide one or more relatively small objects that do not receive focus and function primarily to provide feedback regarding the cursor's position. For example, the objects may be configured such that the objects' appearance, movement, and the like are unresponsive to user input other than user control of the cursor, such as control of the cursor's movement and/or position. As the cursor moves, the objects may also move in a corresponding direction and/or velocity as the cursor. Accordingly, the cursor's movement may closely track the movement of the cursor.

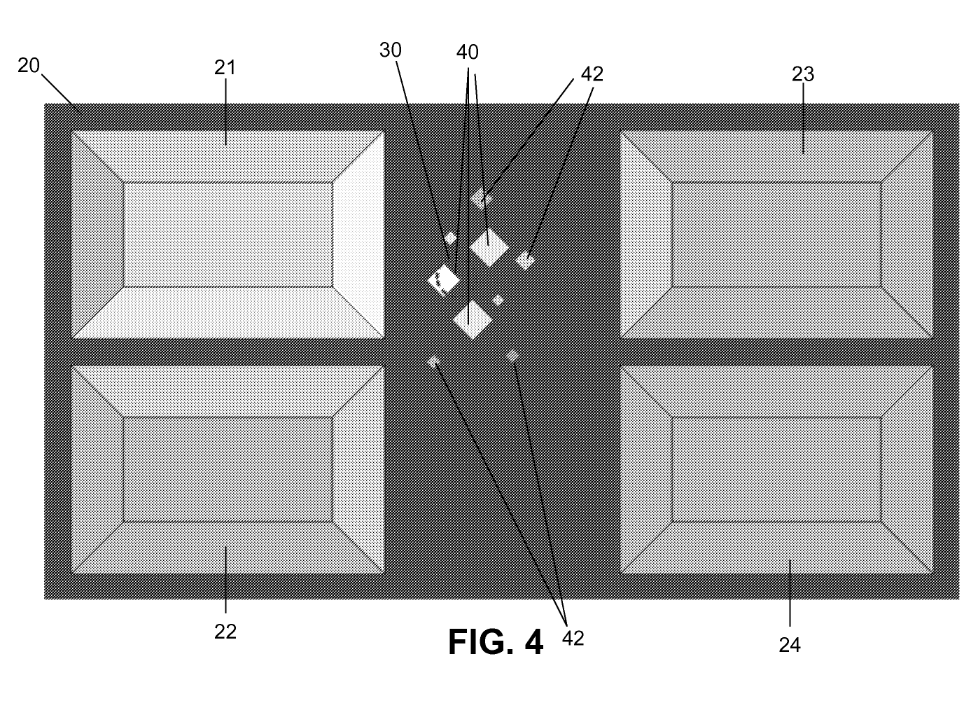

At 34, a plurality of objects may be displayed on a display screen. For example, FIG. 4 depicts an exemplary display screen 20 displaying objects 21-24 that may be altered based on a cursor's position as described herein. The display screen 20 also displays objects 40 and 42 configured to move in a corresponding direction and/or velocity as the cursor, the position and proximate positions of which are indicated by shape 30 as described herein. The objects 21-24 shown in FIG. 4 are not as densely positioned as the objects shown in FIG. 2.

At 36, it is determined whether the cursor is positioned on the display screen 20 at the same position as one or more of the objects 40 and 42, or within a predetermined distance of one or more of the objects 40 and 42. For example, in FIG. 4, objects 40 and 42 are positioned near the cursor's position.

At 38, responsive to user control of the cursor, an appearance of the objects is altered, or the objects are moved, if the cursor is positioned on the display screen at the same position as the objects or within a predetermined distance of the objects. For example, in FIG. 4, objects 40 and 42 move in response to movement of the cursor for indicating to a viewer that the cursor is moving. In addition, objects 40 and 42 are positioned at or in close proximity to the cursor's position such that the viewer can visualize positions proximate to the cursor's position. Although the objects 40 and 42 may not be exactly at the cursor's position, the viewer is able to generally know the cursor's position on the display screen 20.

The objects can be distinguished based on their sizes, color, and/or the like for indicating the cursor's exact position. For example, referring to FIG. 4, the objects 40 can be generally positioned closer to the cursor than the objects 42. The objects 40 are positioned closer to the cursor's position, because the objects 40 are larger than the objects 42. In this way, a viewer can more precisely recognize the cursor's position than if at least some of the objects do not have visually distinct characteristics.

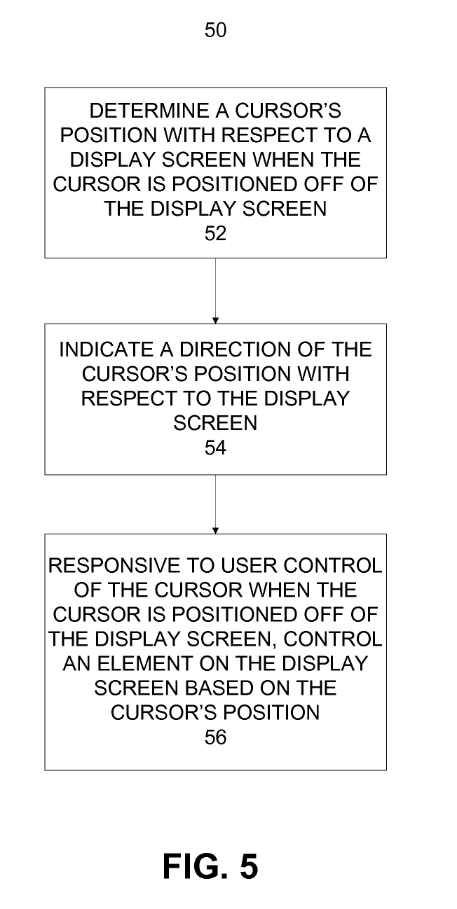

FIG. 5 depicts a flow diagram of an example method for receiving user input based on cursor position. The example method 50 may be used for controlling displayed objects or otherwise interacting with displayed objects when the cursor is positioned off of the display screen. For example, a computer may track a cursor's positioning by a user after the cursor has moved off of the display screen. The distance and direction of movement of the cursor while positioned off of the display screen may be used as inputs for controlling one or more displayed objects. In addition, while the cursor is positioned off of the display screen, a direction of the cursor's position with respect to the display screen may be indicated to the user.

At 52, a cursor's position with respect to a display screen may be determined when the cursor is positioned off of the display screen. For example, a computer may be configured to recognize when the cursor is positioned off of the display screen. In addition, the computer may track a distance, direction, and the like of the movement of the cursor while the cursor is positioned off of the display screen. For example, a mouse movement or gesture of a user's body while the cursor is off of the display screen may be tracked, and the cursor's position off of the display screen moved in accordance with the tracked movement.

At 54, a direction of the cursor's position with respect to the display screen is indicated. For example, one or more objects, such as the object 40 and 42 shown in FIG. 4, may be positioned at or near a side of the display screen that is closest to the cursor's position off of the display screen. Alternatively, other objects and/or features at the side of the display screen may be altered for indicating the position of the cursor nearest to that particular side of the display screen. In another example, an arrow or other similar indicia can be shown on the display for pointing to the direction of the cursor.

At 56, responsive to user control of the cursor when the cursor is positioned off of the display screen, one or more elements on the display screen may be controlled based on the cursor's position. For example, a distance and/or direction of movement of a cursor or a user's body part may be tracked when the cursor is off of the display screen, and a characteristic of an element may be altered based on the distance or direction of movement of the mouse or user's body part. In an example of altering a characteristic of an element on the display screen, the element may be an object that is rotated based on the cursor movement. In other examples, sound, other displayed features of objects, such as colors, brightness, orientation in space, and the like may be altered based on the cursor movement off of the display screen.

By varying the user interface feedback provided by the hidden or invisible cursor along multiple dimensions, the system can further engage the user and create a rich and playful experience for the user. For example, the intensity of the lighting when the cursor acts as a light source as described herein may be modified according to the intensity of the user's interaction, with faster gestures or mouse movements resulting in brighter or differently colored user interface feedback. Similarly, the cursor can interact with various user interface controls in different ways, suggesting materials with different physical properties. The behavior of the cursor can also be themed or personalized, so that one user's cursor interaction affecting a particular region of the display screen will see a different effect than another user's cursor interaction affecting the same region.

In a gesture-based system, the objects may provide additional feedback beyond cursor control. While passive during targeting gestures, the objects may react to symbolic or manipulative gestures, clarifying the mode of interaction and/or providing real-time feedback while the user is executing a gesture.

In another example, a cursor's position may cause alteration of the appearance of normally inactive objects or other features displayed, or hidden, on a display screen. If the cursor's position is at, or within a predetermined distance, of one or more of the inactive objects the appearance of the entire object, a portion of the object, and/or surrounding area, hidden or visible to a viewer, can be altered for indicating the proximity of the cursor's position. For example, a portion of a wallpaper or background image on a display screen may be altered based on the proximity of a cursor.

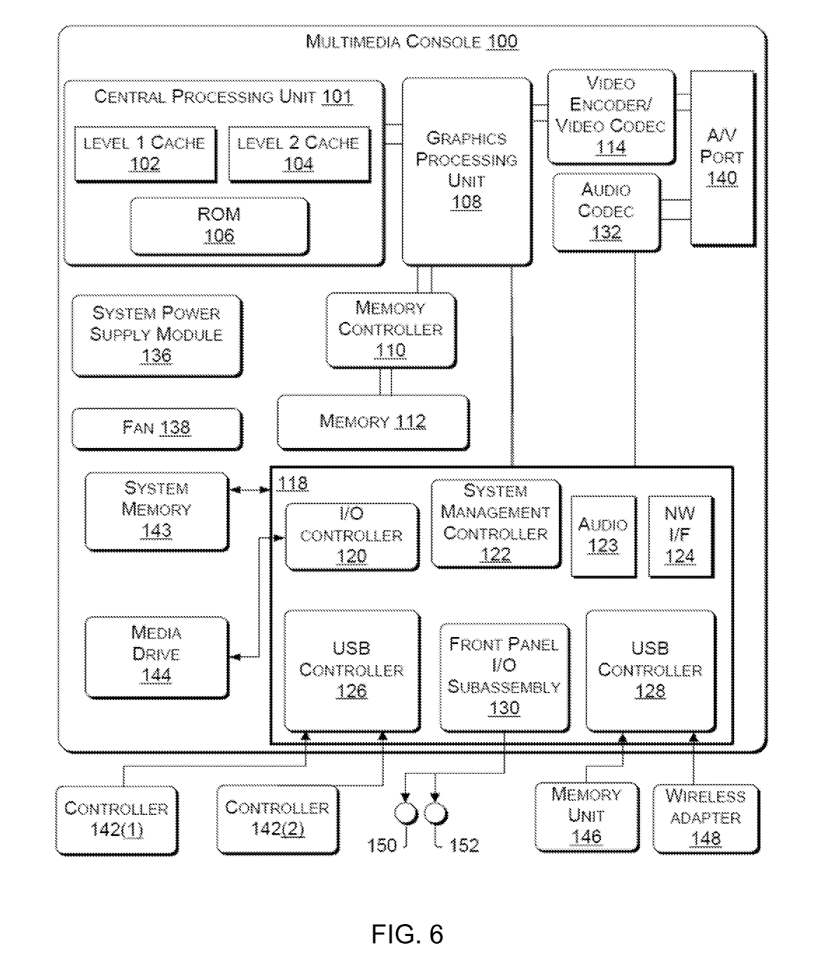

FIG. 6 illustrates an example embodiment of a computing environment that may be used to provide user interface feedback regarding a cursor position on a display screen of an audiovisual device. Further, the computing environment may be used to receive user input based on cursor position when the cursor is positioned off of a display screen of an audiovisual device. The computing environment may be a multimedia console, such as a gaming console, or any suitable type of computer. As shown in FIG. 6, the multimedia console 100 has a central processing unit (CPU) 101 having a level 1 cache 102, a level 2 cache 104, and a flash ROM (Read Only Memory) 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM (Random Access Memory).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 100 is powered ON, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge the gaming application's knowledge and a driver maintains state information regarding focus switches. The cameras 27, 28 and capture device 20 may define additional input devices for the console 100.

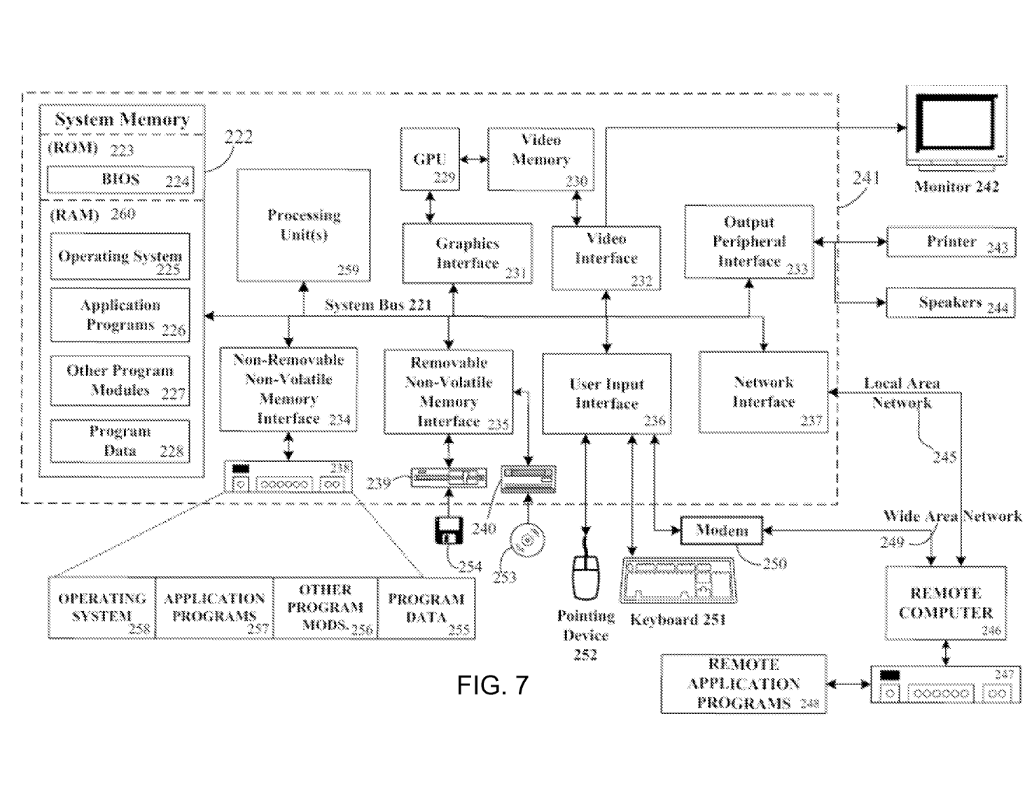

FIG. 7 illustrates another example embodiment of a computing environment that may be used to provide user interface feedback regarding a cursor position on a display screen of an audiovisual device. Further, the computing environment may be used to receive user input based on cursor position when the cursor is positioned off of a display screen of an audiovisual device. The computing system environment is only one example of a suitable computing environment and is not intended to suggest any limitation as to the scope of use or functionality of the presently disclosed subject matter. Neither should the computing environment be interpreted as having any dependency or requirement relating to any one or combination of components illustrated in the exemplary operating environment. In some embodiments the various depicted computing elements may include circuitry configured to instantiate specific aspects of the present disclosure. For example, the term circuitry used in the disclosure can include specialized hardware components configured to perform function(s) by firmware or switches. In other examples embodiments the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

In FIG. 4, the computing environment comprises a computer 241, which typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 4 illustrates operating system 225, application programs 226, other program modules 227, and program data 228.

The computer 241 may also include other removable/non-removable, volatile/nonvolatile computer storage media. By way of example only, FIG. 4 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through a non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 7, provide storage of computer readable instructions, data structures, program modules and other data for the computer 241. In FIG. 7, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). The cameras 27, 28 and capture device 20 may define additional input devices for the console 100. A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 7. The logical connections depicted in FIG. 7 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 7 illustrates remote application programs 248 as residing on memory device 247. It will be appreciated that the network connections shown are exemplary and other means of establishing a communications link between the computers may be used.

It should be understood that the configurations and/or approaches described herein are exemplary in nature, and that these specific embodiments or examples are not to be considered limiting. The specific routines or methods described herein may represent one or more of any number of processing strategies. As such, various acts illustrated may be performed in the sequence illustrated, in other sequences, in parallel, or the like. Likewise, the order of the above-described processes may be changed.

Additionally, the subject matter of the present disclosure includes combinations and subcombinations of the various processes, systems and configurations, and other features, functions, acts, and/or processes disclosed herein, as well as equivalents thereof.

What is claimed:

1. A method for providing user interface feedback regarding a cursor position on a display screen, the method comprising:
displaying an object on the display screen;
determining whether a cursor is positioned on the display screen at a same position as a portion of the object or within a predetermined distance of the portion of the object; and
if the cursor is positioned on the display screen at the same position as the portion of the object or within the predetermined distance of the portion of the object, altering an appearance of the portion of the object.

2. The method of claim 1, wherein the object is configured to be selected for user input when the cursor is positioned on the display screen at the same position as the object.

3. The method of claim 1, wherein altering an appearance of the portion of the object comprises altering one of: a brightness of the portion of the object; a color of the portion of the object; and an appearance of an area at least partially surrounding the portion of the object.

4. The method of claim 1, wherein the portion of the object appears contoured.

5. The method of claim 1, wherein the portion of the object is hidden from view when the cursor is not positioned on the display screen at the same position as the portion of the object or within a predetermined distance of the portion of the object, and
wherein the method comprises altering an appearance of the portion of the object to be visible if the cursor is positioned on the display screen at the same position as the portion of the object or within a predetermined distance of the portion of the object.

6. The method of claim 1 comprising:
displaying another object on the display screen;
determining whether the cursor is positioned on the display screen within the predetermined distance of the portion of the object; and
if the cursor is positioned on the display screen within the predetermined distance of both objects, altering an appearance of portions of the objects.

7. The method of claim 1 comprising focusing on the object if the cursor is positioned on the display screen at the same position as the portion of the object.

8. The method of claim 1 comprising receiving input for changing the cursor's position via one of a user's gesture, a mouse, and a keyboard.

9. A computer readable medium having stored thereon computer executable instructions for providing user interface feedback regarding a cursor position on a display screen, comprising:
displaying a plurality of objects on the display screen;
determining whether a cursor is positioned on the display screen at a same position as one of the objects or within a predetermined distance of one of the objects; and
responsive to user control of the cursor, altering an appearance or moving the one of the objects if the cursor is positioned on the display screen at the same position as the one of the objects or within a predetermined distance of the one of the objects.

10. The computer readable medium of claim 9, wherein the objects are configured such that the objects' appearance and movement are unresponsive to user input other than the user control of the cursor.

11. The computer readable medium of claim 9, wherein the plurality of objects comprise first and second sets of objects, wherein objects of the first set are larger than the objects of the second set, and wherein the objects of the first set are positioned closer to the cursor's position than the objects of the second set.

12. The computer readable medium of claim 9, wherein the objects are positioned within a predetermined distance of the cursor's position.

13. The computer readable medium of claim 12, wherein the computer executable instructions further comprise:
receiving input for changing the cursor's position; and
responsive to movement of the cursor's position, moving the objects to track movement of the cursor's position.

14. The computer readable medium of claim 13, wherein receiving input for changing the cursor's position comprises receiving the input via one of a user's gesture, a mouse, and a keyboard.

15. A method for receiving user input based on cursor position, the method comprising:
determining a cursor's position with respect to a display screen when the cursor is positioned off of the display screen;
indicating a direction of the cursor's position with respect to the display screen; and
responsive to user control of the cursor when the cursor is positioned off of the display screen, controlling an element on the display screen based on the cursor's position.

16. The method of claim 15, wherein determining a cursor's position with respect to a display screen comprises:
tracking a distance and direction of movement of a user's body part; and
moving the cursor's position off of the display screen according the tracked movement.

17. The method of claim 15 comprising:
determining a side of the display screen among the display screen's sides that is closest to the cursor's position; and
displaying an object at the side of the display screen that is closest to the cursor's position.

18. The method of claim 17, wherein the object's movement is responsive to movement of the cursor's position off of the display screen.

19. The method of claim 15, wherein controlling an element on the display screen comprises:
tracking one of a distance and direction of movement of a user's body part; and
altering a characteristic of the element based on the distance or direction of movement of the user's body part.

20. The method of claim 15, comprising receiving user input via one of a user's gesture, a mouse, and a keyboard.
